(19) United States
(12) Patent Application Publication
(10) Pub. No.: US 2011/0238678 A1
(43) Pub. Date: Sep. 29, 2011

(54) APPARATUS AND METHOD FOR PROVIDING OBJECT INFORMATION IN MULTIMEDIA SYSTEM

(75) Inventors: Eun-Seo LEE, Daejeon (KR); Jong-Hyun JANG, Daejeon (KR); Kyeong-Deok MOON, Daejeon (KR)

(73) Assignee: Electronics and Telecommunications Research Institute, Daejeon (KR)

(21) Appl. No.: 13/074,855

(22) Filed: Mar. 29, 2011

(30) Foreign Application Priority Data
Mar. 29, 2010 (KR) 10-2010-0028176

(51) Int. Cl. G06F 17/30

(52) U.S. Cl. 707/755; 707/E17.009

(57) ABSTRACT

An apparatus for providing object information in a multimedia system includes: a receiver configured to receive multimedia contents from a content provider; a parser configured to parse the received multimedia contents and store output information in a memory, the output information corresponding to playback time of objects existing inside the multimedia contents; a controller configured to receive playback time of the multimedia contents from an event generation device, synchronize with the event generation device using the received playback time of the multimedia contents, and receive event information when an event is generated by the event generation device; a comparator configured to retrieve output information corresponding to the event information from the memory; and a display unit configured to display the retrieved output information.

### CROSS-REFERENCE TO RELATED APPLICATIONS

The present application claims priority of Korean Patent Application No. 10-2010-0028176, filed on Mar. 29, 2010, which is incorporated herein by reference in its entirety.

### BACKGROUND OF THE INVENTION

1. Field of the Invention

Exemplary embodiments of the present invention relate to an apparatus and a method for providing object information in a multimedia system; and, more particularly, to an apparatus and a method for providing users with object information in a multimedia system at a user request for the object information.

2. Description of Related Art

Widespread multimedia services of high quality are followed by gradual increase of users' expectations on the level of multimedia services. One of typical technologies in this connection is interactive service technology. However, the current level of interaction between users and multimedia contents is no more than simple control related to playback or display of contents-related information. Therefore, if there exists a method for inserting various types of information (background buildings, characters, costumes of characters) into objects within images so that, when the user touches a specific object, related information is easily acquired, it is expected not only to meet the high service expectations, but also to create a new kind of multimedia contents market.

Such a service, from another point of view, is expected to have a wider range of potential needs in mobile environments. Conventional interactive contents service technologies have the following problem: When a watcher of a moving image is interested in an object, such as a background building within the image, a character, the character's costume or accessory, and the like, he/she is supposed to remember the object of interest and then collect information using a terminal through the Internet, for example, or through a separate channel (e.g. contacting the content service provider).

### SUMMARY OF THE INVENTION

An embodiment of the present invention is directed to an apparatus and a method for providing object information in a multimedia system.

Another embodiment of the present invention is directed to an apparatus and a method for providing users with object information in a multimedia system at a user request for the object information.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for providing object information in a multimedia system includes: a receiver configured to receive multimedia contents from a content provider; a parser configured to parse the received multimedia contents and store output information in a memory, the output information corresponding to playback time of objects existing inside the multimedia contents; a controller configured to receive playback time of the multimedia contents from an event generation device, synchronize with the event generation device using the received playback time of the multimedia contents, and receive event information when an event is generated by the event generation device; a comparator configured to retrieve output information corresponding to the event information from the memory; and a display unit configured to display the retrieved output information.

In accordance with another embodiment of the present invention, a method for providing object information in a multimedia system includes: receiving multimedia contents from a content provider; parsing the received multimedia contents and storing output information in a memory, the output information corresponding to playback time of objects existing inside the multimedia contents; receiving playback time of the multimedia contents from an event generation device and synchronizing with the event generation device using the received playback time of the multimedia contents; receiving event information when an event is generated by the event generation device and retrieving output information corresponding to the event information from the memory; and displaying the retrieved output information.

### BRIEF DESCRIPTION OF THE DRAWINGS

FIG. 1 illustrates the internal structure of an apparatus for providing object information in a multimedia system in accordance with an embodiment of the present invention.

FIG. 2 illustrates an example of inserting metadata into contents by a content author in a multimedia system in accordance with an embodiment of the present invention.

FIG. 3 illustrates an example of metadata for interaction between a multimedia player and an apparatus for providing object information in a multimedia system in accordance with an embodiment of the present invention.

FIGS. 4A and 4B illustrate exemplary service provided by an apparatus for providing object information in a multimedia system in accordance with an embodiment of the present invention.

FIG. 5 illustrates a process of providing object information in a multimedia system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

An example of scene construction using MPEG-4 BIFS (Binary Format for Scenes) will now be described.

Unlike MPEG-1 and MPEG-2, which encode designated videos only, MPEG-4 can encode any type of object and control objects generated by designating parameters, besides encoded videos. Furthermore, screens provided to users by MPEG-4 can switch from a scene consisting of a single video to a scene obtained by synthesizing a plurality of objects. As used herein, scenes include still images, texts, moving images, audios, as well as other types of media objects.

Therefore, there is a need for a scene descriptor for describing the spatial position and time relationship between such objects. Such scene descriptors are standardized by BIFS in MPEG-4. The BIFS refers to a binary language developed based on VRML (Virtual Reality Modeling Language), which is a representative text-type language for describing 3D images. BIFS data consists of a number of nodes which are binary data describing scenes.

That is, according to scene construction using MPEG-4 BIFS, object-based contents constitute a scene. This makes it possible to insert metadata into an object and, when the object is selected by the user, provide the user with metadata corresponding to the selected object.

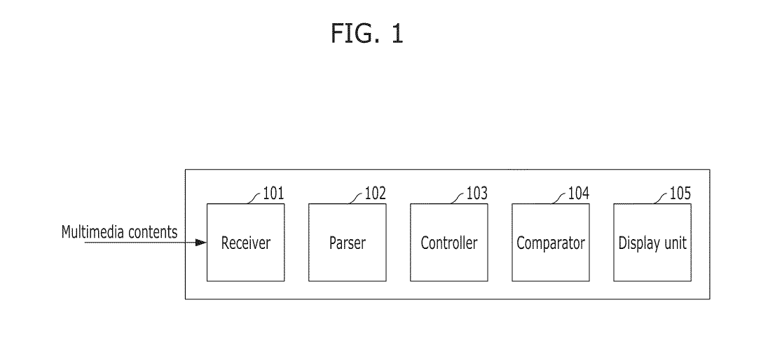

However, in the case of contents which are not constructed based on objects, users cannot be provided with object information. The internal structure of an apparatus for providing object information in a multimedia system in accordance with an embodiment of the present invention will now be described in more detail with reference to FIG. 1.

The apparatus for providing object information in a multimedia system in accordance with an embodiment of the present invention is applicable to a multimedia player, such as a PDA (Personal Digital Assistant), a PMP (Portable Multimedia Player), a MP3 player, a cell phone, a TV set, etc. The multimedia player includes a touch screen.

The user is provided with multimedia contents and metadata from a multimedia CP (Content Provider) through wired/wireless communication, which includes Bluetooth, wired or wireless LAN, but is not limited thereto. It will be assumed in the following description that, when the provided contents are played using the multimedia player, the user touches the screen of the multimedia player using a pen, finger, etc.

FIG. 1 illustrates the internal structure of an apparatus for providing object information in a multimedia system in accordance with an embodiment of the present invention.

Referring to FIG. 1, the apparatus for providing object information in a multimedia system in accordance with an embodiment of the present invention includes a receiver 101, a parser 102, a controller 103, a comparator 104, and a display unit 105. Although not shown in FIG. 1, the controller 103 includes a timer.

The receiver 101 is configured to receive multimedia contents from a CP. The multimedia contents include metadata, which includes information regarding objects inside the contents, such as persons, backgrounds, stuffs, etc., and information regarding the position of the objects on the screen of the multimedia player and their playback time. That is, the multimedia contents include scene-based object information and time information.

The parser 102 is configured to receive multimedia contents from the receiver 101 and store the object position for each playback time and corresponding information using the received multimedia contents. The parser 102 includes a XML parser and an object information parser. An exemplary structure of a memory for storing output information corresponding to the playback time of an object inside the multimedia contents, e.g. object information and object playback position information, will now be described with reference to Table 1 below. Every object inside the multimedia contents includes a memory structure given below.

TABLE 1

```
struct Object [int ID]
{
      int start_time;
      int end_time:
      int x1_position;
      int x2_position;
      int y1_position;
      int y2_position;
      char actress;
};
```

Referring to Table 1 above, the parser 102 uses a struct of C language to deliver information, which has been parsed by an XML parser, to a memory (e.g. one given in Table 1 above) through an object information parser. Those skilled in the art can understand that, although Table 1 above has been described with reference to a struct of C language, it is not limited to a struct of C language, but can also be implemented by another programming language.

The memory includes, based on each object identifier, object generation time (start_time), object ending time (end_time), X coordinates indicating object areas (e.g. x1_position, x2_position), and Y coordinates (e.g. y1_position, y2_position), as well as actress information (actress).

When multimedia contents are played through a multimedia player, the controller 103 synchronizes its timer with the time of the multimedia player. More specifically, the timer of the multimedia player periodically transmits playback time information to the timer of the controller 103, which then synchronizes its timer with the received playback time of the multimedia player.

This process guarantees that synchronization with the multimedia player is maintained even if the user skips or pauses a specific scene while the multimedia contents are being played.

When the touches an object inside the multimedia contents on the screen of the multimedia player using a touch pen or finger, i.e. when an event is generated, the controller 103 transmits information regarding the timer's time at which the event occurred, as well as the position in which the event occurred, to the comparator 104. The structure of information regarding the timer's time at which the event occurred and the position in which the event occurred, which is transmitted from the controller 103 to the comparator 104, will now be described with reference to Table 2 below.

TABLE 2

```
struct touch
{
      int cur_time;
      int x_position;
      int y_position
};
```

Referring to Table 2 above, the controller 103, when the user generates an event, transmits the timer's current time at which the event occurred (cur_time) and information regarding the position in which the event occurred (x_position, y_position) to the comparator 104.

The comparator 104 is configured to receive information regarding the timer's time at which the event occurred and the position in which the event occurred from the controller 103 and compare the data. Specifically, the comparator 104 retrieves objects that are generated at the timer's time at which the event occurred, and retrieves output information regarding an object corresponding to information regarding the position in which the event occurred among the retrieved objects.

The display unit 105 is configured to display output information regarding an object, which has been retrieved by the comparator 104, through a multimedia player. Other embodiments of the present invention will now be described.

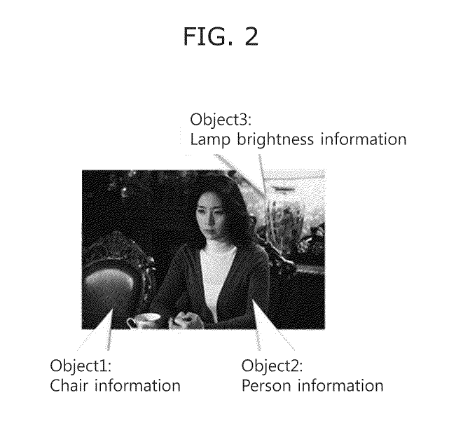

FIG. 2 illustrates an example of inserting metadata into contents by a receiver 101 of an apparatus for providing object information in a multimedia system in accordance with an embodiment of the present invention. The apparatus for providing object information has the same construction as illustrated in FIG. 1.

Referring to FIG. 2, the receiver 101 receives multimedia contents from a CP. The multimedia contents include metadata, which includes information regarding objects inside the contents, such as a chair, specifically its manufacturer, product information, price, vendors, etc.

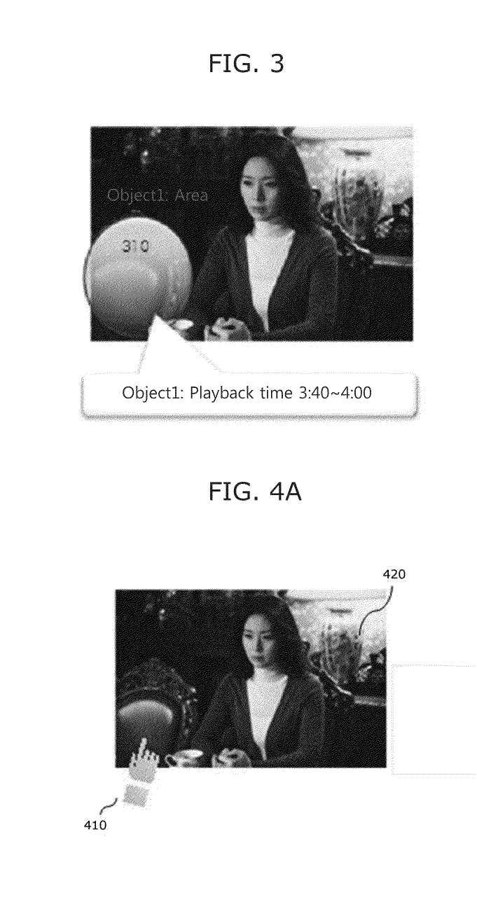

The metadata may also include information regarding persons, information regarding lamp brightness for realistic effect, etc. Metadata for interaction between a multimedia player and an apparatus for providing object information in a multimedia system in accordance with an embodiment of the present invention will now be described in more detail with reference to FIG. 3.

FIG. 3 illustrates an example of metadata for interaction between a multimedia player and an apparatus for providing object information in a multimedia system in accordance with an embodiment of the present invention.

Referring to FIG. 3, the receiver 101 selects an object inside contents and inserts output information regarding an area 310 in which the object is played by the multimedia player, as well as the playback time of the object, i.e. time-based object position and corresponding information.

The time-based object position and corresponding information refer to information which is needed, when the user touches an object through the multimedia player, to retrieve metadata regarding the touched object from the memory.

The metadata has output information corresponding to time of playback by the parser 102 of the apparatus for providing object information in accordance with the present invention, e.g. object information and the object's playback position information, stored in the memory, the structure of which has already been described with reference to Table 1, and repeated description thereof will be omitted herein.

When the multimedia contents are played by the multimedia player and, if the user touches an object inside the multimedia contents using a pen or finger, time information of the timer of the apparatus for providing object information in a multimedia system is synchronized with time information of the timer of the multimedia player, in order to display information regarding the touched object, in the following manner:

The timer of the multimedia player periodically transmits information regarding playback time, which is used to synchronize time information of the timer of the apparatus for providing object information with time information of the timer of the multimedia player. This process guarantees that, even if the user skips or pauses a specific scene while the multimedia contents are being played, synchronization with the multimedia player is maintained.

When the users touches an object inside the multimedia contents on the screen of the multimedia player using a touch pen or finger, i.e. when an event is generated, the user is provided with object information based on comparison of information regarding the timer's time at which the event occurred and the position in which the event occurred.

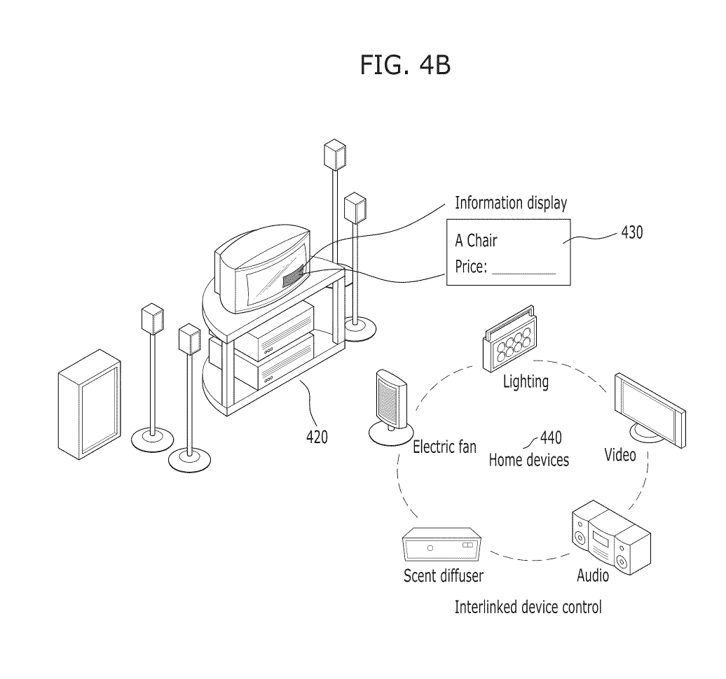

FIGS. 4A and 4B illustrate exemplary service provided by an apparatus for providing object information in a multimedia system in accordance with an embodiment of the present invention. Wherein, FIG. 4A illustrates an example of metadata, and FIG. 4B illustrates the apparatus for providing object information. It will be assumed in the following description that the apparatus for providing object information as illustrated in FIG. 4B has the same construction as illustrated in FIG. 1; the user is watching multimedia contents through a multimedia player 420 at a place where home devices 440, such as a lighting device, an electric fan, a scent diffuser, etc., are installed; and the home devices 440 are connected with the multimedia player in a wired/wireless manner.

Referring to FIGS. 4A and 4B, the user selects a chair 410 inside the multimedia contents using a pen or remote control. The controller 103 of the apparatus for providing object information then transmits information regarding the time at which the user selected the chair 410, i.e. timer's time at which the event occurred, as well as the position in which the event occurred, to the comparator 104 of the apparatus for providing object information.

The comparator 104 of the apparatus for providing object information retrieves objects that are at the timer's time at which the event occurred, and retrieves information regarding the chair 410, which corresponds to information regarding the position in which the event occurred among the retrieved objects. The display unit 105 of the apparatus for providing object information displays information 430 regarding the chair 410.

In addition, the user selects lighting 420 inside the multimedia contents using a pen or remote control. The controller 103 of the apparatus for providing object information then transmits information regarding the time at which the user selected the lighting 420, i.e. timer's time at which the event occurred, as well as the position in which the event occurred, to the comparator 104 of the apparatus for providing object information.

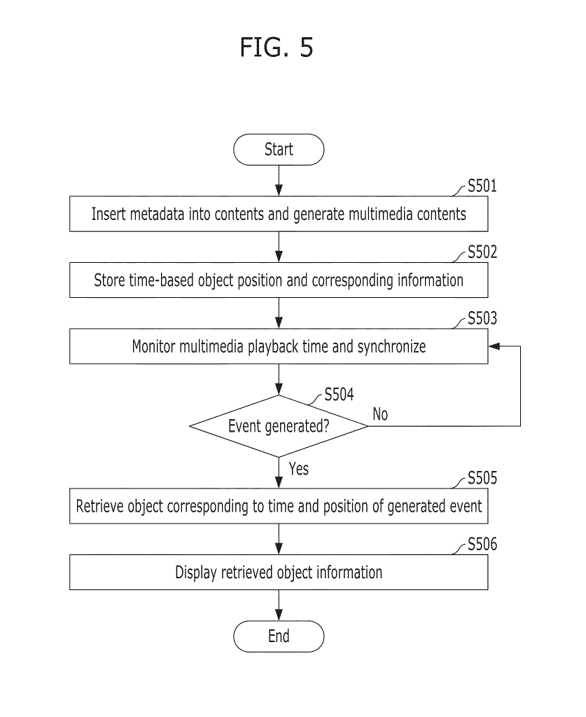

The comparator 104 of the apparatus for providing object information retrieves objects that are generated at the timer's time at which the event occurred, and retrieves information regarding the lighting 420, which corresponds to information regarding the position in which the event occurred among the retrieved objects. The display unit 105 transmits the lighting information, e.g. brightness information, to the lighting device of the home devices 440 so that the degree of lighting is automatically adjusted based on the brightness information. A process of providing object information in a multimedia system in accordance with an embodiment of the present invention will now be described in more detail with reference to FIG. 5.

FIG. 5 illustrates a process of providing object information in a multimedia system in accordance with an embodiment of the present invention.

Referring to FIG. 5, the receiver 101 receives multimedia contents from a CP at step S501. The multimedia contents include metadata, which includes information regarding objects inside the contents, such as persons, backgrounds, stuffs, etc., and information regarding the position of the objects on the screen of the multimedia player and their playback time. Furthermore, the multimedia contents include scene-based object information and time information.

The parser 102 receives multimedia contents and stores the object position for each playback time and corresponding information in the memory using the received multimedia contents at step S502. The parser 102 includes a XML parser and an object information parser. The structure of the memory has already been described with reference to Table 1, and repeated description thereof will be omitted herein.

The controller 103 periodically receives information regarding playback time from the timer of the multimedia player and synchronizes its timer with the received playback time of the multimedia player at step S503. This process guarantees that synchronization with the multimedia player is maintained even if the user skips or pauses a specific scene while the multimedia contents are being played.

The controller 103, while maintaining synchronization as mentioned above, determines if an event has occurred at step S504. When it is determined that no event has occurred, the controller 103 returns to the step S503 and performs synchronization. If the user touches an object inside the multimedia contents on the screen of the multimedia player using a touch pen or finger, i.e. if an event is generated, the comparator 104 receives information regarding the timer's time at which the event occurred and the position in which the event occurred from the controller 103, retrieves objects that are generated at the timer's time at which the event occurred, and retrieves output information regarding the object corresponding to information regarding the position in which the event occurred among the retrieved objects at step S505. The display unit 105 displays the retrieved object information at step S506.

In accordance with the exemplary embodiments of the present invention, users are provided with object information in a multimedia system at their requests. The apparatus for providing object information in accordance with the present invention can be used in connection with a touch screen so that, when a user requests object information using the touch screen, corresponding information is provided. This maximizes services regarding educations, transactions, services, etc.

While the present invention has been described with respect to the specific embodiments, it will be apparent to those skilled in the art that various changes and modifications may be made without departing from the spirit and scope of the invention as defined in the following claims.

What is claimed is:

1. An apparatus for providing object information in a multimedia system, comprising:
a receiver configured to receive multimedia contents from a content provider;
a parser configured to parse the received multimedia contents and store output information in a memory, the output information corresponding to playback time of objects existing inside the multimedia contents;
a controller configured to receive playback time of the multimedia contents from an event generation device, synchronize with the event generation device using the received playback time of the multimedia contents, and receive event information when an event is generated by the event generation device;
a comparator configured to retrieve output information corresponding to the event information from the memory; and
a display unit configured to display the retrieved output information.

2. The apparatus of claim 1, wherein the multimedia contents comprise scene-based object information and time information.

3. The apparatus of claim 1, wherein the parser comprises a XML parser and an object information parser.

4. The apparatus of claim 1, wherein the output information comprises information regarding objects inside the received contents and information regarding playback positions of the objects.

5. The apparatus of claim 1, wherein the event information comprises information regarding time at which the event has been generated by the event generation device and information regarding the position in which the event has occurred.

6. The apparatus of claim 1, wherein the comparator is configured to retrieve objects from the memory using the time information, the objects being played at the time at which the event has occurred.

7. The apparatus of claim 6, wherein the comparator is configured to retrieve object information regarding objects corresponding to the position information, among the retrieved objects, from the memory.

8. The apparatus of claim 1, wherein the memory is configured to store playback start time of objects belonging to the contents, playback end time of the objects, and playback position coordinates of the objects.

9. A method for providing object information in a multimedia system, comprising:
receiving multimedia contents from a content provider;
parsing the received multimedia contents and storing output information in a memory, the output information corresponding to playback time of objects existing inside the multimedia contents;
receiving playback time of the multimedia contents from an event generation device and synchronizing with the event generation device using the received playback time of the multimedia contents;
receiving event information when an event is generated by the event generation device and retrieving output information corresponding to the event information from the memory; and
displaying the retrieved output information.

10. The method of claim 9, wherein the multimedia contents comprise scene-based object information and time information.

11. The method of claim 9, wherein in said parsing the received multimedia contents and storing output information in a memory, the output information corresponding to playback time of objects existing inside the multimedia contents,
the multimedia contents are parsed using a XML parser and an object information parser.

12. The method of claim 9, wherein the output information comprises information regarding objects inside the received contents and information regarding playback positions of the objects.

13. The method of claim 9, wherein the event information comprises information regarding time at which the event has been generated by the event generation device and information regarding the position in which the event has occurred.

14. The method of claim 9, wherein in said receiving event information when an event is generated by the event generation device and retrieving output information corresponding to the event information from the memory,
objects are retrieved from the memory using the time information, the objects being played at the time at which the event has occurred.

15. The method of claim 14, wherein in said receiving event information when an event is generated by the event generation device and retrieving output information corresponding to the event information from the memory,
object information regarding objects corresponding to the position information, among the retrieved objects, is retrieved from the memory.

16. The method of claim 9, wherein the memory stores playback start time of objects belonging to the contents, playback end time of the objects, and playback position coordinates of the objects.
